(19) United States
(12) Patent Application Publication
(10) Pub. No.: US 2002/0080709 A1
(43) Pub. Date: Jun. 27, 2002

(54) Apparatus for recording and reproducing high-density information using multi-functional probe

(76) Inventors: Kang-Ho Park, Taejon (KR); Jeong-Yong Kim, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/906,738

(22) Filed: Jul. 18, 2001

(30) Foreign Application Priority Data
Dec. 22, 2000 (KR) 2000-80893

(51) Int. Cl. G11B 7/125

(52) U.S. Cl. 369/118

(57) ABSTRACT

In the apparatus for recording and reproducing high-density information using a multi-functional probe, media is locally heated not only by near-field optics come out of an aperture and but also by current induced from an end of an conducting cantilever, to record information and thereby increase a recording speed. The apparatus and method for recording and reproducing the high-density information using the multi-functional probe includes a conducting cantilever, in which a cantilever stage and a near-field optical aperture probe are formed in one body, the media is locally heated not only by the near-field optics from a near-field optical aperture probe but also by the current induced from the probe to the media or induced from the probe itself, and then the information is recorded; and an optical detector for reproducing the recorded information with a reflectivity of light come out of the near-field optical aperture probe or a transmission onto the media.

### FIELD OF THE INVENTION

The present invention relates to an apparatus for recording and reproducing high-density information using a multi-functional probe; and more particularly, to an apparatus and a method for recording and reproducing high-density information using a multi-functional probe, in which in writing information, the information is recorded by using a near-field optical aperture probe and a conducting protruding probe, and the recorded information is read by utilizing the near-field optical aperture probe.

### PRIOR ART OF THE INVENTION

In general, in an optical data storage such as a CD or a DVD etc., lens is used in a media structure, to thus lead a phase change of media by using heat generated by focusing light, or to change a magnetization direction of the media by applying magnetic field thereon, thereby the data is recorded and is read by using a reflectivity change of light or a change of a polarization direction.

In such system case, however, a physical size of the recorded information is limited by a diffraction limit of the used light. A diameter of the beam spot is proportional to wavelength of the light and is in inverse proportion to a numerical aperture (NA) of the lens. Thus, in a case of using light of short wavelength, a recording density is high. Since a value of the NA is generally smaller than 1, a magnitude of the recorded information decisively has a limit by wavelength of the light, and a restriction for the magnitude of such information decides a limitation in an increase of the record density. In other words, since wavelength of currently usable laser diode, e.g., a laser diode is about 400˜600 nm, a recording integration over 30 G/in² in the recording density is impossible.

In order to overcome such problems, an endeavor for increasing the recording density is being progressed by using near-field optics based on an evanescent light leaked out through a smaller hole than the magnitude of the wavelength. Traditionally, it is being developed a technique for increasing the recording density by heightening the value of the NA through a use of solid immersion lens (SIL) having a large refraction index, and at present, an attempt for reducing a bit size is being continuously executed by approaching a near-field optics probe to a media surface to embody a further smaller information recording size.

An information writing/reading technique using the near-field optics probe was initially proposed by Betzig et. al. by using an MO(magneto-optic) principle, in the article of Betzig et al., Appl. Phys. Lett., Vol.61, pp.142-144, 1992. It was valid to embody the information bit size of 80 nm by using such technique. Then, the near-field optics recording technique using the SIL, etc. was developed by Kino et. al., but since there is a limit as the NA of about 2-3, the bit size of about 150 nm is regarded as a recording limit, which is described in U.S. Pat. No. 5,982,716 by Kino et al. After that, an optical information writing/reading of compound of Ge—Sb—Te group was performed by Hosaka et. al. through a use of an optical fiber probe, but a throughput of optics is low, with a mechanical weakness, thus a recording time is long taken. That is, there is a limit in a data transfer rate, which is described in an article, “Nanometer-sized phase-change recording using a scanning near-field optical microscope with a laser diode” by Hosaka et al., Jpn. J. Appl. Phys. Part 1, Vol. 35, pp.443-447, 1996.

At present, it is being developed a near-field optical cantilever of an AFM (atomic force microscope) cantilever type having an aperture probe, in order to improve a mechanical stability and the optical throughput, but there is a problem like a restriction in an application to an information storage technique having a practical information recording speed since the throughput is still low.

Meanwhile, it is being partially developed a technique for writing and reading information by using a conducting AFM cantilever. As a most practically applicable technique among them, it was developed a technique of a thermomechanical system in which organic media is heated by thermal energy through its own electric resistance by current flowing in a multi probe of a matrix type, to thereby record information and read its shape and also reproduce the information. But, since the probe and media should contact with each other, directly, deep, when reading and writing the information, there still exists a problem of an error owing to its following wear or vibration of the probe, which is described in an article by Binnig et al., Appl. Phys. Lett. Vol.74, pp.1329-1331, 1999.

In order to complement a stability of such writing/reading system, Kado et. al. had developed a technique of inducing direct current onto the media surface by using a conducting cantilever, or heating the probe by applying light onto an end of the probe, and recording the information by using its following generation heat, which is described in U.S. Pat. No. 6,101,164 by Kado et al. However, also in this technique, the probe and media should directly contact always in recording, and should further contact even when reading the recorded information, thus there is a problem for a stability of the information writing/reading and a life time of the probe.

### SUMMARY OF THE INVENTION

Therefore, it is an object of the present invention to provide an apparatus for recording and reproducing high-density information using a multi-functional probe, which are capable of locally heating media not only by near-field optics from an aperture but also by current induced from an end of a conducting cantilever, and then recording information, to thereby increase a recording speed, when the information is recorded in the media.

Another object of the present invention is to provide an apparatus for recording and reproducing high-density information using a multi-functional probe, which are capable of shortening an information recording time and ultimately improve a data transfer rate, by forming not only near-field optics but also a conductive channel in a cantilever and transferring generation heat provided by self resistance of a conducting protruding probe through a contact with media.

A still another object of the present invention is to provide an apparatus for recording and reproducing high-density information using a multi-functional probe, which are capable of minimizing an error caused due to a wear or a vibration by a contact, in comparison with a system using only an AFM cantilever, by reading a change of a transmission or a reflectivtity using near-field optics come out of an aperture, in reproducing recorded information.

A further object of the present invention is to provide an apparatus for recording and reproducing high-density information using a multi-functional probe, which are capable of overcoming and minimizing a diffraction limit in a recording size, by utilizing near-field optics in reproducing information.

An additional object of the present invention is to provide an apparatus for recording and reproducing high-density information using a multi-functional probe, which are capable of increasing a data transfer rate in proportion to the number of probes by using multiple cantilever.

In accordance with an aspect of the present invention, there is provided an apparatus for recording and reproducing high-density information on a recording media, comprising: a cantilever stage; and a conducting cantilever provided with a near-field optical aperture probe formed therein, wherein the recording media is locally heated by an light beam passing through the near-field optical aperture probe and by a current self-induced from the near-field optical aperture probe to record the high density information on the recording media.

In accordance with another aspect of the present invention, there is provided an apparatus for recording and reproducing high-density information on a recording media, comprising: a conducting cantilever, in which a contact pad is formed on upper and lower parts thereof, a near-field optical aperture probe is formed in one body, a gap between the near-field optical aperture probe and media is controlled by using the contact pad, and a precise control under tens of nanometers is performed with a self-actuating piezoelectric thin film structure, to thus record information in the media; and an optical detector for reproducing the recorded information with a reflectivity of light come out of the near-field optical aperture probe or a transmission onto the media.

In accordance with further another aspect of the present invention, there is provided an apparatus for recording and reproducing high-density information using a multi-functional probe, comprising: a conducting cantilever, in which a cantilever holder and a near-field optical aperture probe are formed in one body, a van der Waals force of the near-field optical aperture probe and media is measured by light reflected thereto, and a gap between the near-field optical aperture probe and the media is controlled by its measured value and a self-actuating piezoelectric structure, to thus record media information; and an optical detector for reproducing the recorded information with a reflectivity of the light come out of the near-field optical aperture probe or a transmission onto the media.

In accordance with still further another aspect of the present invention, there is provided an apparatus for recording and reproducing high-density information on a recording media, comprising: a cantilever stage; and a conducting cantilever provided with a near-field optical aperture probe and a conducting protruding probe formed therein for applying an electrical field to the recording media.

### BRIEF DESCRIPTION OF THE DRAWINGS

The above and other objects and features of the instant invention will become apparent from the following description of preferred embodiments taken in conjunction with the accompanying drawings, in which:

FIG. 1 indicates a constructive diagram of a high-density information recording and reproducing apparatus using a multi-functional probe in a first embodiment of the present invention;

FIG. 2 represents a constructive diagram of a high-density information recording and reproducing apparatus using a multi-functional probe in a second embodiment of the present invention;

FIG. 3 is a constructive diagram of a high-density information recording and reproducing apparatus using a multi-functional probe in a third embodiment of the present invention;

FIG. 4 shows a waveform diagram for a gap distance, optical pulse and electric pulse in recording and reproducing information;

FIG. 5 is a constructive diagram of a high-density information recording and reproducing apparatus using a multi-functional probe in a fourth embodiment of the present invention;

FIG. 6 is a structure diagram of a recording layer shown in FIGS. 1 through 3;

FIG. 7 is a structure diagram of a recording layer shown in FIG. 5;

FIGS. 8A and 8B illustrate structure diagrams of media shown in FIGS. 1 through 3, and FIG. 5; and

FIGS. 9A and 9B depict structure diagrams of media shown in FIGS. 1 through 3 and FIG. 5.

### PREFERRED EMBODIMENT OF THE INVENTION

Hereinafter, preferred embodiments of the present invention will be described in detail with reference to the accompanying drawings.

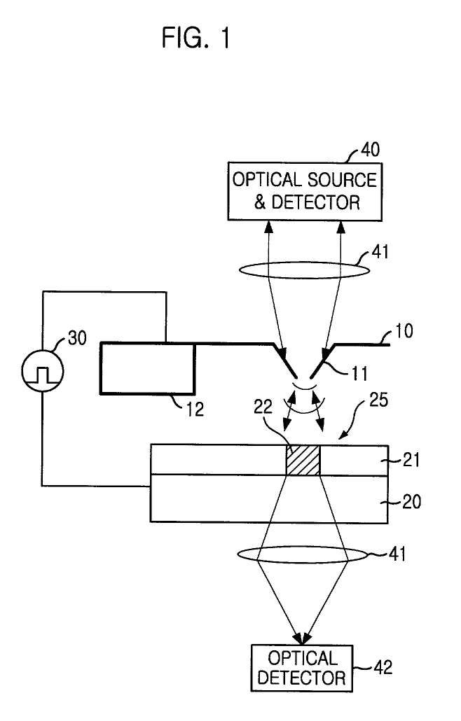

FIG. 1 is a constructive diagram of a high-density information recording and reproducing apparatus using a multi-functional probe in a first embodiment of the present invention.

In FIG. 1, a reference number 10 denotes a conducting cantilever, 11 a near-field optical aperture probe, and 12 a cantilever stage. A reference number 20 denotes a media substrate, 21 a recording layer, and 22 a recording area. A reference number 30 denotes a voltage pulse generator, 40 a light source (LD) and photo detector (PD), 41 lens, and 42 a photo detector (PD).

In a first embodiment of the present invention, information is recorded by a conducting cantilever 10 having a formation of a near-field optical aperture probe 11 which has a conduction, and the recorded information is read by the aperture probe 11. In this embodiment, the conducting cantilever 10 is approached to media 25, and a gap between the media 25 and the cantilever 10 can be controlled.

In order to perform an information writing/reading, it should be provided three requirements, namely, a gap control between the near-field optical aperture probe 11 and the media 25, an information writing through an energy transfer from the near-field optical aperture probe 11 to the media, and an information reproduction using near-field optics.

In the first embodiment of the present invention, an optical recording principle of the media 25 using the near-field optics, and an information recording through heat induced by a movement of current from the conducting cantilever 10 to the media, are valid to record information at the same time, therefore, a recording density and speed can be maximized, with a remarkable increase in an energy output.

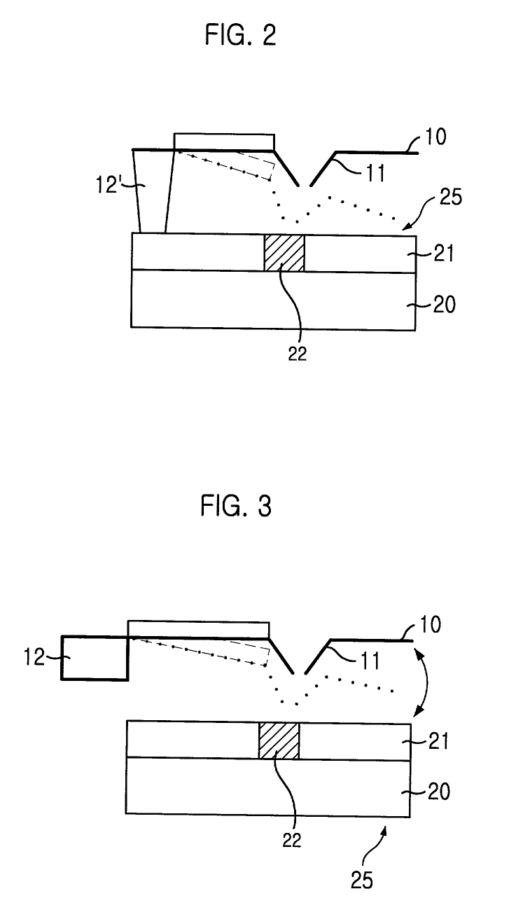

The gap control can be separated into two systems. First, like a second embodiment of the present invention in FIG. 2, a conducting cantilever 10 is formed in a gap with a contact pad 12′ of an insulator, to thereby maintain the gap mechanically. Herewith, the conducting cantilever 10 is formed as a piezoelectric thin film structure.

Secondly, like a third embodiment of the invention shown in FIG. 3, there is an AFM system of measuring a van der Waals force between the probe and the media, and controlling the gap by piezoelectric material.

The AFM system is generally classified into a contact mode and a noncontact mode. The contact mode uses a repulsive force between the cantilever 10 and the sample, meanwhile, the noncontact mode uses an attractive force between the cantilever 10 and the sample.

In a third embodiment of the present invention, the gap control using the noncontact mode is basically used, but it is effective that a momentary approach between the probe and the sample is performed in recording the information.

In a case of using the contact pad 12′ shown in FIG. 2, a high speed scanning over tens of cm/s is valid in the scanning speed, thus there is a merit in an increase of a transmission speed of data, but it is caused a demerit such as a wear of the media or a low energy transfer efficiency in the data recording since an interval between the near-field optical aperture probe 11 and the media 25 is generally large.

In order to overcome such weakness, together with the contact pad technique, it can be used a system that the cantilever is manufactured with piezoelectric material in an actuator structure and a minute gap is controlled in such structure. In a case of the contact mode in the gap control of the AFM system shown in FIG. 3, there is a shortcoming such as the wear of the media 25 and the near-field optical aperture probe 11 or an easily breaking problem of the probe, meantime, the energy transfer efficiency in the data recording can be maximized. In a case of the gap control of the AFM noncontact mode, a wear problem of the probe 11 and the media 25 is small, but there is a demerit of lowering a scanning speed because of a limitation in the gap control using resonance frequency of the probe 11.

The near-field optical aperture probe 11 is made with basic material such as silicon, silicon oxide, and silicon nitride, and on its surface, metallic material such as Au, W, Pt, Cr, Ti, Al, Co, W2C, TiC, TiN, or diamond etc. is coated, therefore, the probe is a conducting structure. Further, in a case of the media 25, it has a bulk substrate or its thin film has a conduction, thus the media 25 is a conducting structure.

In an energy transfer from the near-field optical aperture probe 11 to the media 25, in a case of using only near-field optics and assuming that an optical output of use laser diode, e.g., a laser power is 10 mW, a throughput of a general optical probe is about 10⁻⁴ in an area of 100 nm, therefore an optical output focused onto the media 25 is 1 μW and in a case of an inorganic substance phase transition thin film based on a thickness of about 20 nm as Ge—Sb—Te group, a change time from crystal to amorphous is about 1 ms and it is 1 kb/s when turning it into a recording speed.

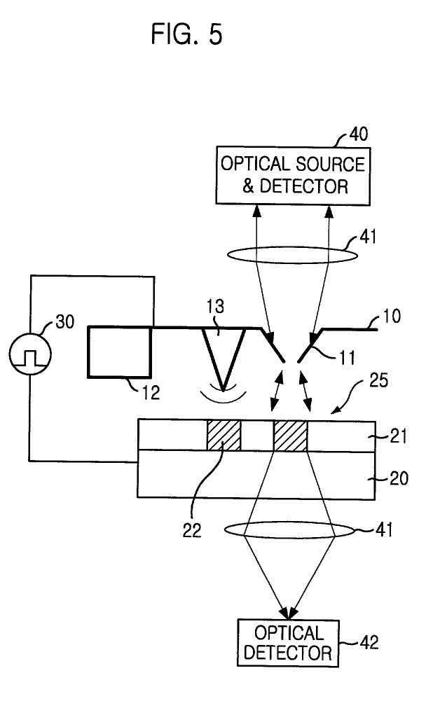

However, if voltage between a conducting protruding probe 13 and media 25 shown in FIG. 5 is 10V and current induced therebetween is 100 μA, an energy output by electric resistance is 1 mW. That is, a recording time is about 1 μsec, and if this is turned into the recording speed, it becomes 1 Mb/s, which can contribute to an improvement of the recording speed.

In reading the recorded information, the information is reproduced in a procedure of reading a difference of an optical absorption of the recorded media by using only the near-field optics without using a conduction between the probe 11 and the media 25. In such information reproduction, a required optical output is small, and the probe 11 and the media 25 do not have to completely contact with each other, thus its reproducing speed is rapid and a wear of the probe 11 and the media 25 is small, which therefore becomes an important kernel element.

In a case of using such information writing/reading system, it can be obtained an information recording density of 100 G/in² having a recording size of 100 nm. Also the writing/reading speed is valid to be 1 Mb/s, and in a case of using a multi probe, it is valid in principle to embody the data transfer rate of 10˜100 Mbps.

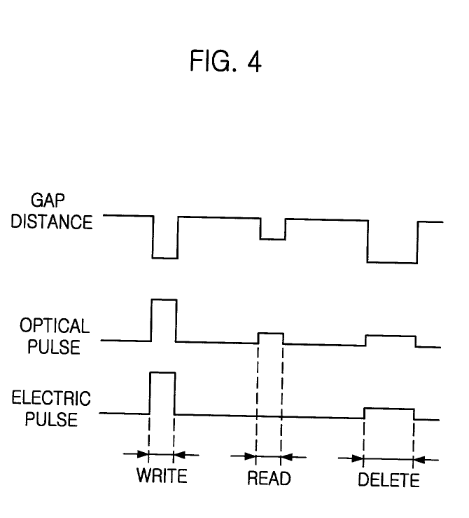

FIG. 4 represents a change of optics, electric signal and a probe gap during writing, reading and erasing the information.

In recording the information, the gap between the probe and the media is reduced, and optical and voltage pulse is applied, to thus lead a change in the structure of the media. The recorded information is read according that the gap becomes more distant, optical pulse smaller than that in performing the writing is inputted, and a signal of reflected or permeated light is measured.

In a case of the media based on a WORM (write-once-read-many) type, once recorded information can't be changed, thus, after that, only a procedure of reproducing the information only with the optical signal is repeated. In a case of such rewritable media as phase change recording material, the probe is approached so as to transfer only energy of some lower output in comparison with the case of the writing, thereby it is led a phase change from an amorphous type to a crystal type to erase the recorded information. In such procedures the information is written, read and erased.

FIG. 5 is a constructive diagram of a high-density information recording and reproducing apparatus using a multi-functional probe in a fourth embodiment of the present invention.

A reference number 13 indicates a conducting protruding probe, and the rest reference numbers have the same construction as FIG. 1, thus have the same reference numbers.

In a case of FIG. 1, there may be a case that the near-field optical aperture structure can not perform its function well, since a wear and a damage of the probe 11 occur in writing the information. To settle such problem, as shown in FIG. 5, it is provided a separate-type double probe cantilever in which the conducting protruding probe 13 and the near-field optical aperture probe 11 are formed in order in one cantilever 10.

In order for an exact tracking or seeking necessary in the information writing/reading, an interval between two probes should be manufactured as a precision rate below tens of nanometers. Also, the AFM type probe should be projected more than the near-field optical probe, but its height difference should be under 100 nm. The conducting protruding probe 13 is used in writing the information, and the written information uses a mechanism for performing a reading through the near-field optical aperture probe 11.

In writing the information, it is utilized generation heat occurring by electric resistance from the conducting protruding probe 13 to the media 25, or it may be used generation heat in which the protruding probe having a large resistivity is heated by its self resistance. In a case of the later, the media does not have to be conducted, thus there is a merit that the media of a electric insulator can be utilized.

The probe gap control and the optical and electric signal control of the information writing/reading are performed similarly to one body-type probe, but there is a difference that the optical signal is not used in writing the information.

Generally, the used media has, as its target, inorganic material and organic material utilized in the optical recording, and in a case of the inorganic material, phase change material representative by Ge—Sb—Te is usable, and it is all usable if it is conducting material changeable in phase or shape such as a metal thin film and a semiconductor etc.

In its material, it can be provided the phase change material selected from Ge, Sb, Te, Sn, Ga, Se, Pb, Bi, In, Ag, Sn, S, and Al etc. Such phase change material generally has an electric conduction and can use a difference in an optical absorption and a conduction, therefore there is an advantage.

In another material, there is metal and a semiconductor such as Au, Ag, Cu, Zn, Cd, Ga, In, Eu, Gd, Ti, Pb, Pd, Al, Sb, Bi, Te, Ge, and Si etc. In such material, its morphology is changed or fused with each other by heat, to form alloy or silicide, therefore it is valid to perform the writing and reading by using a change of an optical characteristic.

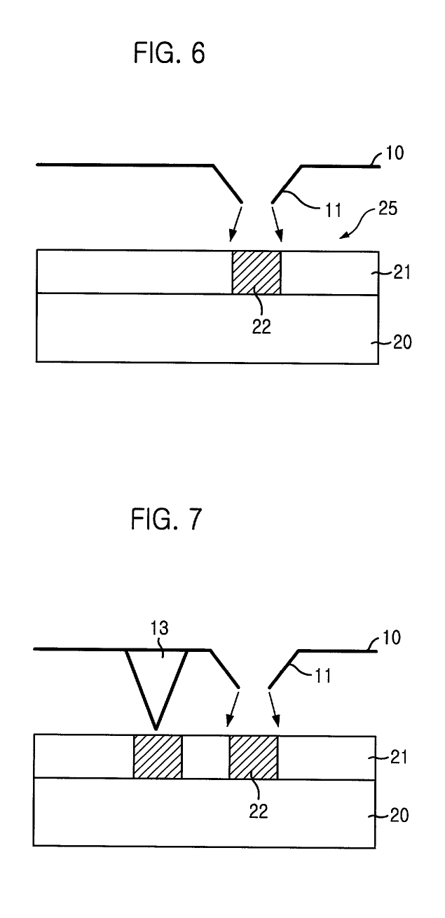

Further, in material such as Ti, an oxide film is partially formed by the conducting probe, to record the information, and this can be also used without a protective film or with a thin protective film, as shown in FIG. 6. Also it can be used as a double or multi thin film shape. In a case of the double or multi thin film, it is valid to perform the writing and reading by leading the difference in the absorption rate of light gotten in a mutual fusion result and by using a change in the amount of light. In the substrate, all of metal, a semiconductor and an insulator such as glass and quartz etc., are usable.

As shown in FIG. 7, in case that the conducting protruding probe 13 and the near-field optical aperture probe 11 are separated and stuck onto one cantilever, sample is heated by current flowing in the conducting protruding probe 13 and the information is recorded, and it is usable the media for reading the recorded information by the near-field optical aperture probe 11.

In the conducting media, the information is written by heat generated by directly flowing of current from the probe to sample, and in the media of insulator, the information can be recorded by contacting the probe with the media by resistance heat generated from the probe having a large resistivity through a current flowing in the cantilever.

When a metal thin film is deposited on the substrate, clusters are formed by a Volmer-Weber growth as shown in FIG. 7, and in such formed metal clusters, generally the absorption of light by a surface plasmon is largely increased in comparison with a bulk. When the heat through an irradiation of focused light and current is applied onto the formed cluster, its size and distribution are changed, to thus change the absorption of optics. Such change is used as the information recording and the recorded information is read by optics, thereby the information can be reproduced. But, in such cluster case, since the information cannot be erased after the writing once, it can be used as only media of a WORM (Write-Once-Read-Many) type.

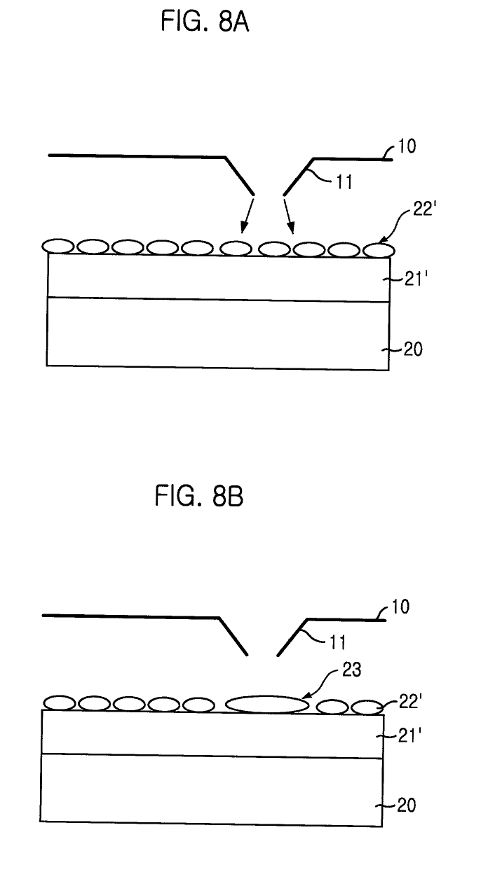

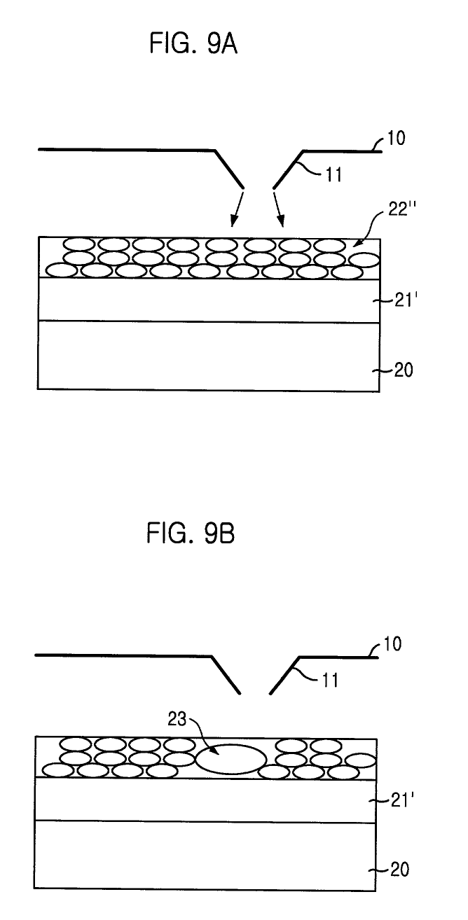

As shown in FIGS. 9A and 9B, in a method of forming a cluster thin film, when a vacuum chamber is filled with inert gas and metal is evaporated, the hot metal atom collides with cold gas, and a condensation between metal and metal is formed and is deposited on the sample surface, thus a shape shown in FIGS. 8A and 8B can be provided. The merit in such method is to form a cluster thin film which is thick from tens of nanometers to several microns.

When the formed thin film is heated by light and electricity, the clusters are combined with each other, to form a metal thin film, and the difference in its following absorption of light is led, to thus write and read the information, which is also usable by only write-once system. As the substrate, all of metal, a semiconductor and an insulator are usable.

The thin film has a conducting metal multi-layer structure or a metal-semiconductor multi-layer structure, and is deposited and evaporated on various substrates, to thereby lead a morphological change through heat, a formation of an oxide film, an alloying between material, or a formation of a compound, record the information by the electricity pulse through the near-field optics and probe, and reproduce the information through the near-field optics.

As another media, organic material is usable. An organic thin film is formed on metal and a semiconductor substrate having conduction, and a molecular structure of the organic material and a phase change are thus led by a heating procedure through light and electricity, and the information can be recorded and reproduced by using the difference of the optical absorption. In such used organic material, there are PMMA, poly carbonate, polyimid, azo-benzene, diarylethene compound, NBMN (3-nitrobenzal malonitrile), pDA(1,4-phenylendiamine), spiero-benzene, cyanine and phthalocyanine and optical-recording liquid crystal polymer etc. According to some cases, the organic material thin film and the metal cluster can be used together with and its example is as Ligand stabilized metal cluster. Beyond, material of an oxide thin film or carbon group can be utilized as the material with a morphological change, a phase change and a compositional transition.

As afore-mentioned, in accordance with the present invention, not only optical energy but also electric energy is applied onto media by using a double functional cantilever probe, whereby a recording time can be shortened and a cause of an error through a wear or vibration of a probe can be minimized by reproducing information with near-field optics.

In addition, in the invention it is valid to realize a recording time below a microsecond, therefore, a recording speed of Mbit/s can be achieved, and a speed of reproducing the information is around Mbit/s. Accordingly, the existing weakness of the probe type information storage can be remarkably improved. In case that such double functional probe is manufactured in an array type and is used as a multi cantilever structure, a practical use of tera byte information storage is valid in its data transmission speed and seeking time.

Furthermore, it is ultimately valid to embody an information recording technique of 10 nm class in case that a size of the probe is reduced.

It will be apparent to those skilled in the art that various modifications and variations can be made in the present invention without deviating from the spirit or scope of the invention. Thus, it is intended that the present invention cover the modifications and variations of this invention provided they come within the scope of the appended claims and their equivalents.

What is claimed is:

1. An apparatus for recording and reproducing high-density information on a recording media, comprising:
a cantilever stage; and
a conducting cantilever provided with a near-field optical aperture probe formed therein, wherein the recording media is locally heated by an light beam passing through the near-field optical aperture probe and by a current self-induced from the near-field optical aperture probe to record the high density information on the recording media.

2. The apparatus of claim 1, further comprising an optical detector for reproducing the recorded high density information with a reflectivity of light come out of the near-field optical aperture probe.

3. The apparatus of claim 2, further comprising:
a laser diode for generating a laser beam; and
a lens for focusing the laser beam on the recording media.

4. The apparatus of claim 3, wherein the laser diode is a micro surface emission laser (VCSEL).

5. The apparatus of claim 1, wherein the recording media includes a crystal-amorphous phase changeable material.

6. The apparatus of claim 1, wherein the recording media includes a conducting cluster material.

7. The apparatus of claim 1, wherein the recording media includes a thin film having a metal-semiconductor multi-layer structure.

8. An apparatus for recording and reproducing high-density information on a recording media, comprising:
a conducting cantilever, in which a contact pad is formed on upper and lower parts thereof, a near-field optical aperture probe is formed in one body, a gap between the near-field optical aperture probe and media is controlled by using the contact pad, and a precise control under tens of nanometers is performed with a self-actuating piezoelectric thin film structure, to thus record information in the media; and
an optical detector for reproducing the recorded information with a reflectivity of light come out of the near-field optical aperture probe or a transmission onto the media.

9. An apparatus for recording and reproducing high-density information using a multi-functional probe, comprising:
a conducting cantilever, in which a cantilever holder and a near-field optical aperture probe are formed in one body, a van der Waals force of the near-field optical aperture probe and media is measured by light reflected thereto, and a gap between the near-field optical aperture probe and the media is controlled by its measured value and a self-actuating piezoelectric structure, to thus record media information; and
an optical detector for reproducing the recorded information with a reflectivity of the light come out of the near-field optical aperture probe or a transmission onto the media.

10. An apparatus for recording and reproducing highdensity information on a recording media, comprising:
a cantilever stage; and
a conducting cantilever provided with a near-field optical aperture probe and a conducting protruding probe formed therein for applying an electrical field to the recording media.

11. The apparatus of claim 10, further comprising:
a laser diode for generating a laser beam; and
a lens for focusing the laser beam on the recording media.

12. The apparatus of claim 11, further comprising an optical detector for reproducing the recorded information with a light beam reflected from the recording media.

13. The apparatus of claim 12, wherein the laser diode is a micro surface emission laser (VCSEL).

14. The apparatus of claim 10, wherein the recording media includes a crystal-amorphous phase changeable material.

15. The apparatus of claim 10, wherein the recording media includes a conducting cluster material.

16. The apparatus of claim 10, wherein the recording media includes a thin film having a metal-semiconductor multi-layer structure.

17. The apparatus of claim 10, wherein the recording media is formed by a conducting thin film structure and is in contact with the conducting protruding probe by generation heat through electricity resistance of the conducting protruding probe itself, to increase a temperature and thereby record the information, and also reproduce the information through the near-field optics.

18. The apparatus of claim 10, wherein the recording media is formed by an insulating thin film structure and is in contact with the conducting protruding probe by the generation heat through the electricity resistance of the conducting protruding probe itself, to thus increase the temperature and thereby record the information, and also reproduce the information through the near-field optics.
